(19) United States
(12) Patent Application Publication
(10) Pub. No.: US 2010/0326962 A1
(43) Pub. Date: Dec. 30, 2010

(54) WELDING CONTROL SYSTEM

(75) Inventors: Eklavya Calla, Bangalore (IN); Sandip Maity, Bangalore (IN); Umakant Damodar Rapol, Bangalore (IN); Alan Joseph Silvia, Clifton Park, NY (US)

Correspondence Address: GE Energy-Global Patent Operation;Fletcher Yoder PC, P.O. Box 692289, Houston, TX, 77269-2289, US

(73) Assignee: GENERAL ELECTRIC COMPANY, Schenectady, NY (US)

(21) Appl. No.: 12/491,158

(22) Filed: Jun. 24, 2009

(51) Int. Cl. B23K 9/04

(52) U.S. Cl. 219/76.14; 219/76.1

(57) ABSTRACT

In one embodiment, a system includes a welding controller configured to receive images from multiple observation points directed toward a deposition zone. The welding controller is also configured to control a parameter affecting deposition based on a differential analysis of the images.

### BACKGROUND OF THE INVENTION

The subject matter disclosed herein relates to a welding control system and, more specifically, to a system for adjusting welding parameters based on stereoscopic bead visualization.

Defects may develop during automated welding operations due to improper welder settings. For example, an output power of a welder, a feed rate of material into the welding zone and/or a speed of the welder relative to a workpiece may not be properly configured for a particular welding operation. These improper settings may result in unsatisfactory weld beads. For example, the weld bead may not have a proper height, width and/or penetration depth into the workpiece. Furthermore, the welder may wear away workpiece material surrounding the welding zone, a condition known as undercut. Such defects may degrade weld quality, thereby resulting in a weaker joint. Moreover, additional time-consuming and expensive finishing operations may be performed to correct the defects. Therefore, it may be desirable to monitor weld bead deposition and automatically adjust welder parameters to compensate for detected defects.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a welder configured to deposit a weld bead on a workpiece. The system also includes multiple cameras directed toward the weld bead and configured to generate respective images. Furthermore, the system includes a controller configured to generate a stereoscopic image of the weld bead from the images and to adjust a parameter of weld bead deposition based on the stereoscopic image.

In a second embodiment, a system includes a welding controller configured to receive images from multiple observation points directed toward a deposition zone. The welding controller is also configured to control a parameter affecting deposition based on a differential analysis of the images.

In a third embodiment, a system includes multiple cameras directed toward a workpiece and configured to generate respective images of a welding zone on the workpiece. The system also includes a controller configured to generate a three-dimensional image of the welding zone based on the images. The controller is also configured to adjust a parameter affecting formation of a weld bead within the welding zone based on the three-dimensional image.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an automated welding system having a stereoscopic vision system configured to adjust welding parameters based on weld bead visualization in accordance with certain embodiments of the present technique;

FIG. 2 is a block diagram of the automated welding system of FIG. 1 in which outputs of a welding laser and light source are directed toward a welding zone via an objective lens in accordance with certain embodiments of the present technique;

FIG. 3 is a schematic diagram of two cameras directed toward the welding zone and configured to determine weld bead height in accordance with certain embodiments of the present technique;

FIG. 4 is a block diagram of the automated welding system of FIG. 2 including additional cameras and a light source directed toward a reverse side of the welding zone in accordance with certain embodiments of the present technique;

FIG. 5 is a flowchart of a method for operating an automated welder based on stereoscopic images of the welding zone in accordance with certain embodiments of the present technique;

FIG. 6 is a flowchart of a method for detecting welding defects and/or weld bead properties in accordance with certain embodiments of the present technique; and

FIG. 7 is a flowchart of a method for adjusting a parameter affecting weld bead deposition in accordance with certain embodiments of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure may enhance weld quality associated with automated welding systems by stereoscopically observing a welding zone and adjusting welding parameters based on detected defects and/or weld bead properties. Specifically, an automated welding system may include a welder configured to deposit a weld bead onto a workpiece. In certain embodiments, a light source may be configured to illuminate the welding zone. Multiple cameras may be directed toward the weld bead and configured to output images of weld bead formation. The cameras may be communicatively coupled to a controller configured to generate a stereoscopic or three-dimensional image of the weld bead from the output images. Alternatively, the controller may be configured to perform a differential analysis on the output images to compute various geometric properties of the weld bead. For example, the controller may be configured to compute a height and/or width of the weld bead. Furthermore, the controller may be configured to detect undercut into the workpiece material adjacent to the welding zone. In certain embodiments, a second set of multiple cameras may be positioned on a reverse side of the workpiece, opposite from the welder. These cameras may also be directed toward the weld bead and configured to output images to the controller. The controller may stereoscopically analyze these images to compute a penetration depth of the weld bead into the workpiece. In further embodiments, the controller may perform a spectroscopic analysis of the images to determine temperature and/or composition of the weld bead. Based on the geometric and spectral data the controller may adjust a parameter of weld bead deposition to enhance welder performance and/or to compensate for the detected defect. For example, the controller may adjust welder output power, speed of the welder relative to the workpiece and/or feed rate of material into the welding zone. In other words, the controller may establish a feedback loop based on the stereoscopic images to enhance control of the automated welding system.

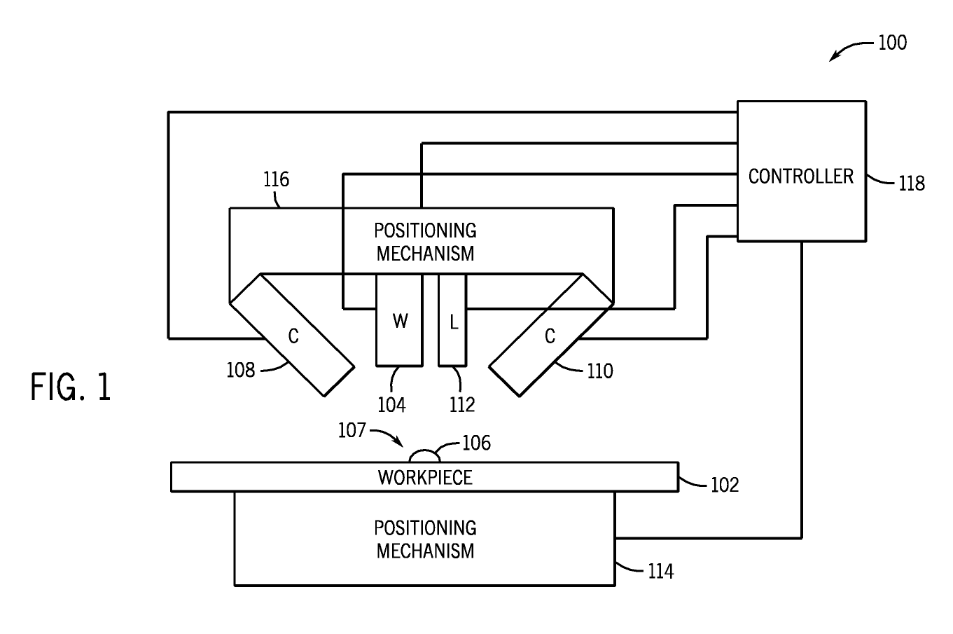

FIG. 1 is a block diagram of an automated welding system 100 having a stereoscopic vision system configured to adjust welding parameters based on weld bead visualization. Specifically, the automated welding system 100 includes a workpiece 102 and a welder 104. The welder 104 may be configured to deposit a weld bead 106 onto the workpiece 102. The workpiece 102 may include two or more pieces of material (e.g., metal, plastic, etc.) placed adjacent to one another. In certain embodiments, the welder 104 heats the workpiece material, while simultaneously depositing filler material into a welding zone 107. The combination of heat and deposited filler material may form the weld bead 106, and induce fusion of the constituent elements of the workpiece, thereby forming a welded joint.

Any suitable welder 104 may be incorporated within the automated welding system 100. For example, welder 104 may be an electron beam welder, in which high-velocity electrons impact the workpiece. Kinetic energy from the electron impacts may generate sufficient heat to melt material within the welding zone 107, thereby fusing elements of the workpiece 102 together. Alternatively, the welder 104 may be a friction stir welder that includes a rotating bit placed adjacent to two abutting plates of a workpiece. Heat generated from the friction of the rotating bit against the workpiece 102 may soften the material of each plate, while the spinning motion mixes the softened material together, thereby forming a fused joint. The welder 104 may also be an ultrasonic welder, in which ultrasonic energy induces material in the workpiece 102 to soften and mix with surrounding material to form a fused joint. In further embodiments, welder 104 may be an arc welder such as a tungsten inert gas (TIG) welder, a metal inert gas (MIG) welder, a shielded metal arc welder (SMAW), or a flux-cored arc welder (FCAW), among others. Each type of arc welder employs an electrode that establishes an electrical arc with the workpiece 102. Heat from the arc may melt workpiece material within the welding zone 107, while additional filler material (e.g., steel, aluminum, titanium, etc.) is deposited, thus forming the weld bead 106. The welder 104 may also be a gas welder that combusts a fuel (e.g., acetylene, butane, propane, etc.) in the presence of an oxidizer (e.g., liquid oxygen or air) to produce sufficient heat to melt material within the welding zone 107 and establish a fused joint. In certain embodiments, the welder 104 may be an atomic hydrogen welder, in which molecular hydrogen is separated into atomic hydrogen by an electrical arc between two electrodes. As the hydrogen recombines, sufficient heat may be released to melt the workpiece material. Another type of welder 104 that may be employed in the automatic welding system 100 is a plasma welder. A plasma welder heats a working gas via an electrical arc and then expels the gas at high speed (e.g., approaching the speed of sound). The hot gas may melt the material of the workpiece 102 upon contact, thereby establishing a fused joint. Another welder 104 configuration that may be employed in the automated welding system 100 is a welding laser. As discussed in detail below, radiation emitted from a welding laser may be focused on the workpiece 102, thereby melting the constituent material and forming a weld bead 106. In certain embodiments, the welding laser may be combined with another welder configuration such as plasma, TIG or MIG to form a laser-hybrid welder. Such a combination may increasing weld penetration depth and/or welding speed, for example.

The automated welding system 100 also includes at least a first camera 108 and a second camera 110. Both cameras 108 and 110 are directed toward the weld bead 106 on the workpiece 102. As discussed in detail below, the position of these cameras 108 and 110 may be configured to obtain a three-dimensional or stereoscopic image of the welding zone 107. A stereoscopic image may be formed by combining two two-dimensional images taken from different perspectives. Specifically, the location of reference points within each two-dimensional image may be compared to compute a depth of each reference point relative to the cameras 108 and 110. In this manner, a stereoscopic image may be created which includes a three-dimensional position of each reference point. While the cameras 108 and 110 are positioned on opposite sides of the weld bead 106 in the illustrated embodiment, it should be appreciated that the cameras 108 and 110 may be positioned on the same side in alternative embodiments. Furthermore, while two cameras 108 and 110 are employed in the present embodiment, alternative embodiments may include more cameras, such as 3, 4, 5, 6, 7, 8, 9, 10 or more cameras to observe different perspectives of the welding zone 107. In addition, the cameras 108 and 110 may be still cameras configured to provide individual images of the workpiece 102 or video cameras capable of capturing multiple images per second. For example, the cameras 108 and 110 may employ a charge coupled device (CCD) or a complementary metal oxide semiconductor (CMOS) to capture images and output digital signals indicative of the images.

In certain configurations, at least one light source 112 may be provided to illuminate the welding zone 107. The light source 112 may be an incandescent or fluorescent bulb, one or more light emitting diodes (LEDs), or a laser (e.g., diode laser), for example. In certain configurations, the light source 112 is positioned adjacent to the welder 104 such that the light source 112 is substantially perpendicular to the weld bead 106. This configuration may provide effective lighting for each camera 108 and 110 to obtain a properly illuminated image of the weld bead 106. Alternative embodiments may include multiple light sources 112 positioned at various locations proximate to the workpiece 102 and directed toward the weld bead 106. For example, in certain embodiments, a light source 112 may be disposed on each camera 108 and 110 and directed toward the welding zone 107.

The workpiece 102 may be coupled to a first positioning mechanism 114 configured to move (e.g., translate, rotate, or both) the workpiece 102 relative to the welder 104. Similarly, the welder 104, along with the cameras 108 and 110 and the light source 112, may be coupled to a second positioning mechanism 116 configured to move (e.g., translate, rotate, or both) the welder 104 relative to the workpiece 102. This configuration may enable the welder 104 to deposit a weld bead 106 along the surface of the workpiece 102. As discussed in detail below, the speed of the workpiece 102 relative to the welder 104 may affect properties of the weld bead 106.

The welder 104, the cameras 108 and 110, the light source 112, and the positioning mechanisms 114 and 116 may be communicatively coupled to a controller 118. Specifically, the controller 118 may be configured to receive images from the cameras 108 and 110, and adjust parameters of the welder 104 and/or the positioning mechanisms 114 and 116 based on the images. For example, the controller 118 may be configured to combine images from cameras 108 and 110 to form a stereoscopic or three-dimensional image of the welding zone 107. Additionally, the controller 118 may be configured to perform a differential analysis on the images from the cameras 108 and 110 to compute geometric properties of the weld bead 106. This stereoscopic, three-dimensional or differential image may enable the controller 118 to detect welding defects such as undercut, improper bead height, improper bead width and/or improper penetration depth. In addition, the controller 118 may be configured to provide a spectroscopic analysis of the images from cameras 108 and 110 to determine temperature of the weld bead 106 and/or bead composition. The controller 118 may then adjust parameters of the welder 104 and/or positioning mechanisms 114 and 116 to compensate for the detected defect or weld bead properties. For example, the controller 118 may adjust welder power output and/or feed rate of material into the weld bead 106. In addition, the controller 118 may control the rate of welder motion relative to the workpiece 102 via the positioning mechanisms 114 and/or 116. Adjusting welder parameters to compensate for detected weld bead defects or properties may enhance weld bead formation, provide stronger weld joints, and substantially reduce or eliminate time-consuming and expensive finishing operations.

In alternative embodiments, the system 100 may be configured to deposit a coating on the workpiece 102. For example, the system 100 may include an oxygen fuel flame coating device and/or a plasma coating device. Similar to weld bead deposition, the coating device may apply a layer of material to the workpiece 102. The cameras 108 and 110 may then observe the deposition of this layer, while controller 118 adjusts deposition parameters based on detected coating thickness and/or composition, for example. Similarly, the controller 118 may be configured to detect voids, gaps or imperfections in the coating layer. This configuration may enhance deposition quality by adjusting deposition parameters to compensate for detected coating defects and/or properties.

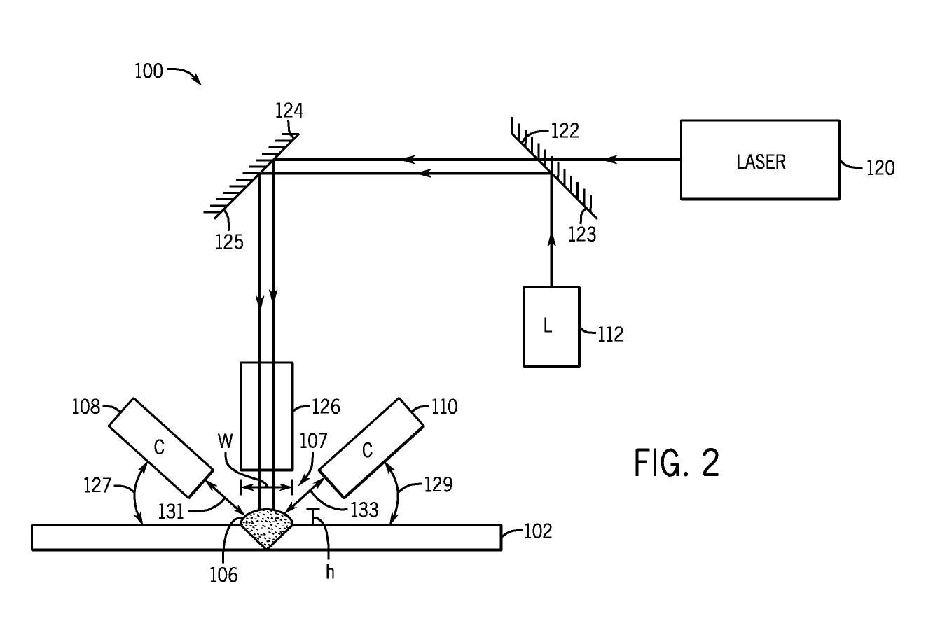

FIG. 2 is a block diagram of the automated welding system 100 of FIG. 1 in which outputs of a welding laser and light source are directed toward a welding zone 107 via an objective lens. The illustrated embodiment includes a welding laser 120, a dichroic mirror 122, a second mirror 124 and an objective lens 126. The welding laser 120 may include various types of lasers configured to apply heat to the workpiece 102, thereby welding the constituent components. For example, the welding laser 120 may include a solid-state or gas laser. Solid-state lasers include a gain medium such as neodymium doped yttrium aluminum garnet (Nd:YAG) or neodymium doped glass (Nd:glass) that is optically pumped to induce emissions of laser radiation by a flash lamp or laser diode, for example. Gas lasers include a sealed gaseous medium such as carbon dioxide, hydrogen, nitrogen, and/or helium that is electrically pumped to induce emissions of laser radiation. In certain embodiments, the welding laser 120 is configured to emit laser radiation in the infrared spectrum (e.g., wavelengths between approximately 700 nm to 100 microns). Such wavelengths may be well suited for laser welding because they may provide sufficient heat to the workpiece 102 to melt the constituent elements and facilitate proper fusion. Welding lasers 120 may be configured to emit a continuous or pulsed beam. As appreciated, output power of pulsed lasers may be adjusted by varying pulse width and/or pulse frequency.

As illustrated, laser radiation is directed toward the dichroic mirror 122, while light from the light source 112 is directed toward the dichroic mirror 122 at an angle approximately perpendicular to the direction of laser radiation. The dichroic mirror 122 includes a reflective surface 123 configured to reflect light of a first frequency, while allowing light of a second frequency to pass through. For example, the dichroic mirror 122 may be configured to reflect visible light, while allowing infrared radiation to pass through. In such a configuration, if the welding laser 120 is configured to emit infrared radiation and the light source 112 is configured to emit visible light, the laser radiation may pass through the dichroic mirror 122 while the visible light is reflected by the surface 123. In this configuration, both light from the light source 112 and infrared radiation from the welding laser 120 may exit the dichroic mirror 122 in a substantially parallel direction, impact a reflective surface 125 of the second mirror 124, and be directed toward the objective lens 126. In alternative embodiments, the position of the welding laser 120 and the light source 112 may be reversed such that light from the light source 112 passes through the dichroic mirror 122 and laser radiation from the welding laser 120 is reflected by the surface 123.

The objective lens 126 may be configured to direct both the laser radiation and the visible light toward the welding zone 107 of the workpiece 102. An objective lens is a compound lens system positioned adjacent to an object of interest (e.g., workpiece 102). As appreciated, an index of refraction of a lens may vary based on wavelength of the refracted light. Therefore, lens 126 may be particularly configured to focus both visible light from the light source 112 and infrared radiation from the welding laser 120 on the weld bead 106. This configuration may both illuminate the weld bead 106 such that the cameras 108 and 110 may observe the welding zone 107, and focus the laser radiation on the workpiece 102 such that sufficient energy is delivered to melt the constituent materials and induce proper fusion. In certain embodiments, the objective lens 126 may be configured to focus the visible light over a larger area than the laser radiation.

As appreciated, the welding process itself may emit light sufficient to illuminate the welding zone 107. However, due to the magnitude of this light, the cameras 108 and 110 may not be able to capture images directly from the welding zone 107. Therefore, the cameras 108 and 110 may be directed toward an area of the bead 106 behind the welding zone 107 (i.e., where the bead 106 has already been formed). In such an arrangement, light from the welding zone 107 may not be sufficient to illuminate the weld bead 106. Therefore, light from the light source 112 may be directed toward this region to properly illuminate the weld bead 106 for the cameras 108 and 110. In such an embodiment, the objective lens 126 may be configured to focus the laser radiation on the welding zone 107, while focusing the light on a different region of the weld bead 106.

As previously discussed, cameras 108 and 110 may be directed toward the weld bead 106 to monitor various aspects of formation. As illustrated, an angle 127 between camera 108 and the workpiece 102 and an angle 129 between camera 110 and the workpiece 102 may be selected such that each camera 108 and 110 has a direct, unobstructed view of the weld bead 106. In certain embodiments, the angles 127 and 129 may be substantially the same such that each camera 108 and 110 observes the weld bead 106 from substantially similar perspectives. In alternative embodiments, the angles 127 and 129 may be different to provide cameras 108 and 110 with diverse views of the weld bead 106. For example, in certain embodiments, camera 108 may be directed toward the center of the weld bead 106, while camera 110 is directed toward the intersection between the weld bead 106 and the workpiece 102. Such an arrangement may enable each camera 108 and 110 to view different regions of the welding zone 107. Angles 127 and 129 may range from approximately 0° to 90°, 5° to 80°, 10° to 70°, 15° to 60°, or about 15° to 45° in certain embodiments.

Furthermore, as illustrated, camera 108 is positioned a distance 131 from the weld bead 106, and camera 110 is positioned a distance 133 from the weld bead 106. In certain embodiments, these distances 131 and 133 may be substantially the same. Alternative embodiments may include differing distances 131 and 133 such that each camera 108 and 110 examines a different region of the welding zone 107. For example, the distance 131 may be less than the distance 133. In this configuration, camera 108 may observe a specific region of the weld bead 106, while camera 110 captures the entire welding zone 107. A similar arrangement may be accomplished by varying the focal length of each camera 108 and 110. For example, the distances 131 and 133 may be substantially similar, but camera 108 may have a larger focal length such that the camera 108 is focused on a particular region of the weld bead 106. As appreciated, the cameras 108 and 110 may be positioned a sufficient distance from the welding zone 107 to ensure that the cameras 108 and 110 are not exposed to excessive heat that may interfere with camera operation.

In certain embodiments, the cameras 108 and 110 may include a filter positioned between a camera lens and the welding zone 107 to reduce the magnitude and/or limit the frequency of light entering the camera lens. For example, the filter may include an ultraviolet (UV) filtering element configured to protect the light detecting element (e.g., CCD or CMOS) from UV radiation emanating from the welding zone 107. Similarly, the filter may be configured to block infrared (IR) radiation from the welding laser 120. Furthermore, the filter may be configured to reduce the magnitude of visible light entering the cameras 108 and 110. For example, in certain embodiments, the welding process may emit intense electromagnetic radiation in the visible spectrum. Such emissions may overload the sensitive light detecting elements within the cameras 108 and 110. Therefore, the filter may enable the cameras 108 and 110 to effectively capture images from the welding zone 107.

The cameras 108 and 110 are configured to capture images electronically and transmit the captured images to the controller 118. The controller 118 may analyze the images by forming a stereoscopic or three-dimensional image, or by performing a differential analysis on the captured images. The controller 118 may then determine a bead height (h) and/or a bead width (w) based on the analysis. Bead height (h) is the height of the bead 106 with respect to a baseline position. For example, as illustrated, the baseline position is the surface of the workpiece 102 facing the cameras 108 and 110. Therefore, bead height (h) may be defined as the height of the bead 106 relative to the workpiece surface. Bead width (w) is the width of the bead 106 perpendicular to the direction of bead formation (e.g., along the surface of the workpiece 102). As discussed in detail below, various parameters (e.g., welder output, filler feed rate and/or welder speed) may affect bead height (h) and/or bead width (w). The controller 118 may be configured to adjust parameters of the welder 104 and/or the positioning mechanisms 114 and 116 to establish a desired bead height (h) and/or bead width (w). Providing feedback control of bead height (h) and/or bead width (w) based on stereoscopic visualization may enhance weld bead formation and substantially reduce or eliminate finishing operations.

While two cameras 108 and 110 are illustrated in the present embodiment, it should be appreciated that one camera may be employed to capture images from two different perspectives to create a stereoscopic image or enable the controller 118 to perform a differential analysis of the images. For example, in certain embodiments, two fiber optic cables may extend to lenses positioned proximate to the weld bead 106 at different observation points. These fiber optic cables may be coupled to a multiplexer to provide the camera with images from each observation point. Specifically, images from each fiber optic cable may be multiplexed in space or time. For example, if the camera is configured to multiplex the images in space, each fiber optic cable may project an image onto a different portion of a camera image sensing device (e.g., CCD or CMOS). In this configuration, an image from one observation point may be directed toward an upper portion of the image sensing device, while an image from the other observation point may be directed toward a lower portion of the image sensing device. As a result, the image sensing device may scan each image at half resolution. In other words, scan resolution is inversely proportional to the number of spatially multiplexed signals. As appreciated, lower resolution scans provide controller 118 with less information about the weld bead 106 than higher resolution scans. Therefore, the number of spatially multiplexed signals may be limited by the minimum resolution sufficient for controller 118 to identify welding defects and/or weld bead properties. Alternatively, images provided by fiber optic cables may be multiplexed in time. For example, the camera (e.g., video camera) may alternately scan an image from each observation point using the entire resolution of the image sensing device. Using this technique, the full resolution of the image sensing device may be utilized, but the scanning frequency may be reduced proportionally to the number of observation points scanned. For example, if two observation points are scanned and the camera frame rate is 200 frames per second, the camera is only able to scan images from each observation point at 100 frames per second. Therefore, the number of temporally multiplexed signals may be limited by the desired scanning frequency.

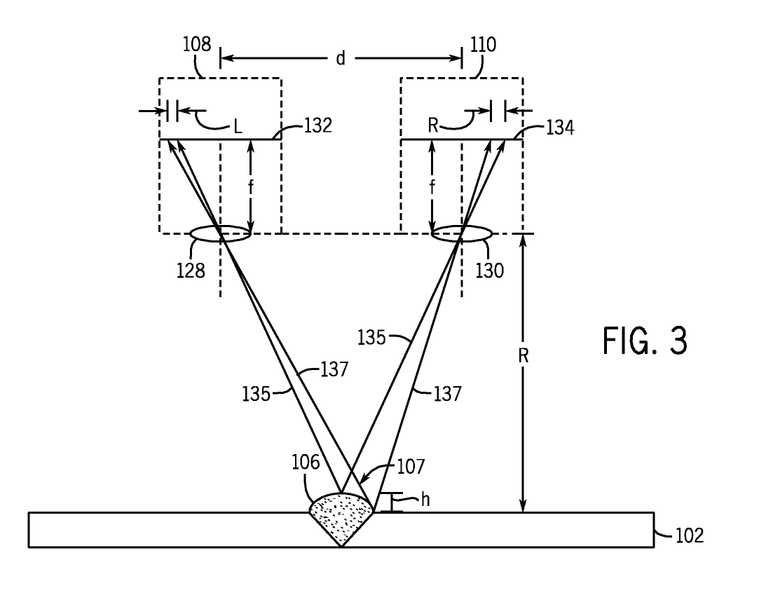

FIG. 3 is a schematic diagram of two cameras 108 and 110 directed toward the welding zone 107 and configured to determine weld bead height (h). As previously discussed, one method in which the controller 118 may compute bead height (h) is through a differential analysis of the images from each camera 108 and 110. As illustrated, camera 108 includes a lens 128 and camera 110 includes a lens 130. Lens 128 is positioned a distance (f) away from a light sensing element 132 of camera 108. Similarly, lens 130 is positioned a distance (f) away from a light sensing element 134 of camera 110. As appreciated, the distance (f) corresponds to the focal length of the lenses 128 and 130. While the focal length (f) of each camera 108 and 110 is the same in the present embodiment, the focal lengths (f) of the cameras 108 and 110 may vary in alternative embodiments.

Each camera 108 and 110 is positioned a distance (d) apart and a distance R from the workpiece 102. These distances may be particularly configured to enable each camera 108 and 110 to view the weld bead 106 from a similar perspective. Light emitted from the weld bead 106 (e.g., via reflected light from the light source 112) passes through lens 128 and lens 130, and is projected on the light sensing elements 132 and 134, respectively. For example, light rays 135 emitted from a point at the weld bead height (h) and light rays 137 emitted from a point at a base of the weld bead 106 may pass through each lens 128 and 130, and impact the light sensing elements 132 and 134. A distance between the projection points of light ray 135 and light ray 137 on element 132 is represented as a distance L. Similarly, a distance between the projection points of light ray 135 and light ray 137 on element 134 is represented as a distance R. Based on the difference in length between L and R and the geometric configuration of the welding system 100, the weld bead height (h) may be computed. Specifically, the weld bead height (h) may be calculated according to the following equation:

$$h = \frac{df}{R - L}$$

As appreciated, the position and orientation of the cameras 108 and 110 may be varied in alternative embodiments. Such variations may result in a modified relationship between the weld bead height (h) and the distances L and R. However, it should be appreciated that regardless of the particular configuration, the weld bead height (h) may be computed based on a differential analysis of images from cameras 108 and 110 positioned at varying locations proximate to and directed toward the weld bead 106. Based on the measured weld bead height (h), the controller 118 may adjust certain welder parameters to ensure that the bead height (h) corresponds to an established range. In this manner, proper weld bead formation may be achieved, thereby enhancing joint strength and substantially reducing or eliminating finishing operations.

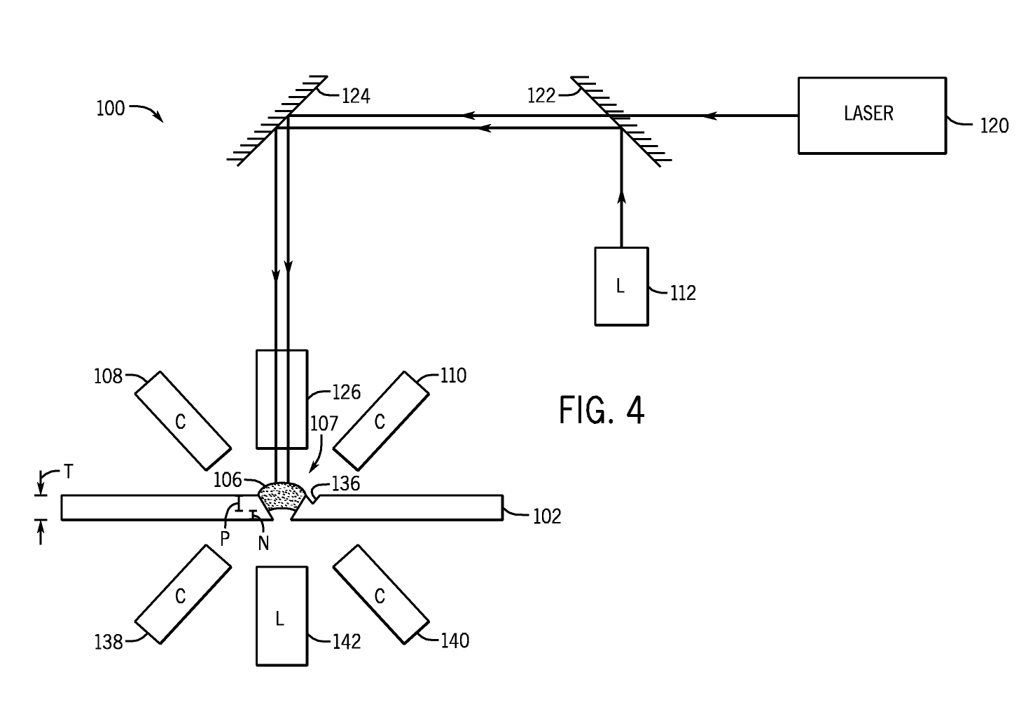

FIG. 4 is a block diagram of the automated welding system 100 of FIG. 2 including additional cameras and at least one light source directed toward a reverse side of the welding zone 107. Specifically, the present embodiment includes a camera 138 positioned on a substantially opposite side of the workpiece 102 from camera 108, and a camera 140 positioned on a substantially opposite side of the workpiece 102 from camera 110. Both cameras 138 and 140 are directed toward the reverse side of the weld bead 106. In addition, the present embodiment includes a light source 142 positioned on a substantially opposite side of the workpiece 102 from the objective lens 126, and configured to project light substantially perpendicular to the workpiece 102. Similar to the light source 112, the light source 142 may include any suitable light generating mechanism such as an incandescent or fluorescent bulb, one or more LEDs and/or a laser diode, for example. The light source 142 may be positioned such that the reverse side of the weld bead 106 is illuminated with sufficient intensity for the cameras 138 and 140 to observe the bead 106.

Because cameras 138 and 140 are positioned on the reverse side of the bead 106, the cameras 138 and 140 may not be able to observe the bead height (h) and the bead width (w). However, the cameras 138 and 140 may be configured to generate images indicative of penetration depth P. As appreciated, strength of the weld may be dependent upon achieving complete penetration of the weld bead 106 through the workpiece 102. Therefore, positioning cameras 138 and 140 on the reverse side of the workpiece 102 may enable the controller 118 to compute penetration depth P based on a differential analysis or generation of a stereoscopic or three-dimensional image of the welding zone 107. For example, the controller 118 may perform a similar computation to the method described above with regard to computing weld bead height (h). Specifically, the controller 118 may perform a differential analysis of images from cameras 138 and 140 to compute a distance N between a surface of the workpiece 102 facing cameras 138 and 140 and the weld bead 106. Penetration depth P may then be computed by subtracting the distance N from a thickness T of the workpiece 102. In this manner, the controller 118 may adjust welding parameters to ensure that a proper penetration depth P is achieved.

In addition, FIG. 4 illustrates an undercut 136 into the workpiece 102 that may be observed by cameras 108 and 110. Undercut 136 is a condition in which material of the workpiece 102 adjacent to the welding zone 107 is worn away. Specifically, improper welder output power and/or improper speed of the welder 104 relative to the workpiece 102 may cause undercut 136 because excessive workpiece material is melted and flows into the weld bead 106. Because undercut 136 may reduce the strength of the workpiece 102, expensive and time-consuming repair operations may be performed if the undercut 136 condition is present, thereby increasing manufacturing costs. Consequently, automatic control of welding parameters (e.g., welder output power and/or welder speed) based on stereoscopic visualization may substantially reduce or eliminate undercut 136, thus decreasing manufacturing costs.

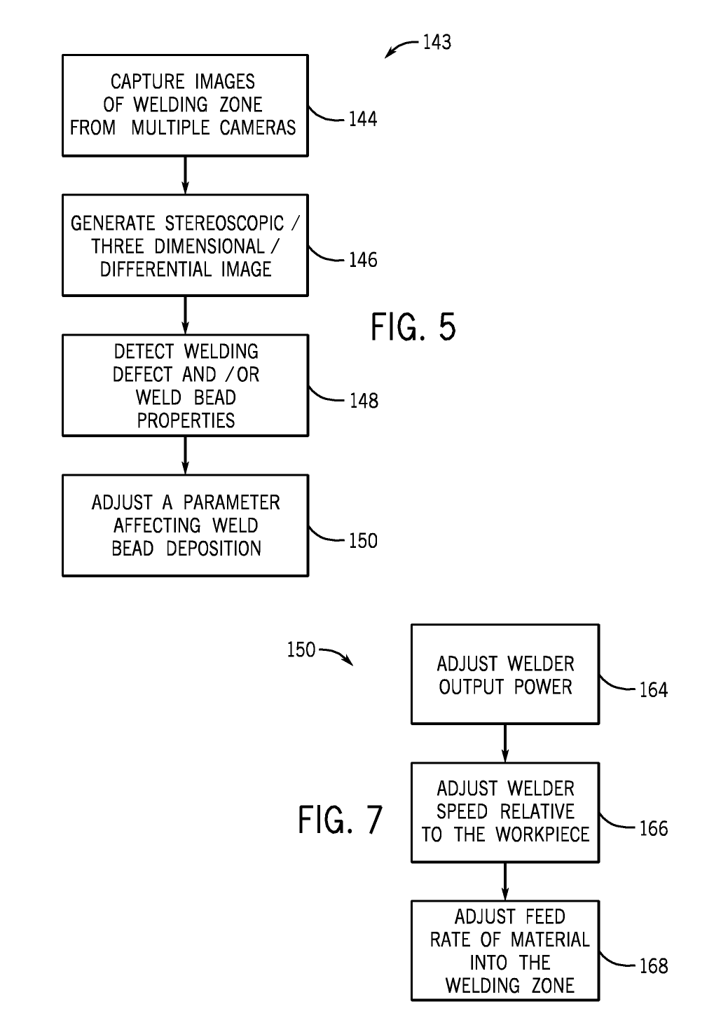

FIG. 5 is a flowchart of a method 143 for operating an automated welding system 100 based on stereoscopic images of the welding zone 107. First, as represented by block 144, images of the welding zone 107 are captured from multiple cameras. As previously discussed, this step may include capturing images from a single camera coupled to multiple fiber optic cables via a spatial or temporal multiplexer. Stereoscopic, three-dimensional or differential images are then generated, as represented by block 146. For example, the controller 118 may compute weld bead height (h) based on the computation described above by performing a differential analysis of the images from the cameras 108 and 110. Alternatively, the controller 118 may be configured to generate a stereoscopic or three-dimensional image of the welding zone 107 to compute properties such as weld bead height (h), width (w) and/or penetration depth P.

Next, as represented by block 148, welding defects and/or weld bead properties may be detected. For example, controller 118 may include a desired range of weld bead heights (h). The controller 118 may monitor weld bead height (h) and compare the computed value to the desired range. If the computed weld bead height (h) is outside of the established range, a welding defect may be detected. Similar ranges may be input into the controller 118 for weld bead width (w) and/or penetration depth P. The controller 118 may then compare the computed weld bead width (w) and/or penetration depth P to the established ranges to detect welding defects.

The controller 118 may also be configured to perform a spectroscopic analysis on the weld bead 106 to determine temperature and composition. Specifically, as appreciated, every chemical element emits different spectral emissions as electrons within the constituent atoms become excited and relax to the ground state. Certain welding techniques (e.g., arc welding, gas welding, laser-hybrid welding, etc.) may provide sufficient energy to the welding zone 107 to excite electrons within atoms of the workpiece 102 and/or filler. By observing the spectral emissions of the welding zone 107, the composition of the weld bead 106 may be determined. For example, the controller 118 may perform a spectroscopic analysis of the images from cameras 108 and 110, and generate a series of emission lines. The controller 118 may then compare the emission lines to stored emission lines of known chemical elements, thereby determining which elements are present within the welding zone 107. For example, in certain embodiments, a filler material may be added to the weld bead 106 to provide enhanced fusion between components of the workpiece 102. The filler material may include different chemical elements than the workpiece. In such a configuration, the controller 118 may detect the amount of filler deposited within the weld bead 106 based on a spectroscopic analysis of the atoms that comprise the weld bead 106. In this configuration, the controller 118 may determine whether an appropriate amount of filler is being added to the weld bead 106.

Because the quality of the weld may be affected by the temperature at which the weld bead 106 is deposited on the workpiece 102, the controller 118 may be configured to determine temperature of the welding zone 107 based on spectral emissions. Specifically, by determining the constituent elements within the welding zone 107 and observing the intensity of emissions at various frequencies, the temperature of the welding zone 107 may be computed. The controller 118 may then determine if the temperature deviates from an established range.

Based upon detection of a welding defect or a property of the weld bead 106, a parameter affecting weld bead deposition may be adjusted, as represented by block 150. For example, the output power of the welder 104 may be adjusted, the speed at which the welder 104 moves relative to the workpiece 102 may be adjusted and/or the feed rate of filler material may be adjusted. In this manner, a proper weld bead 106 may be formed, thus improving weld quality and decreasing time and expense associated with finishing operations.

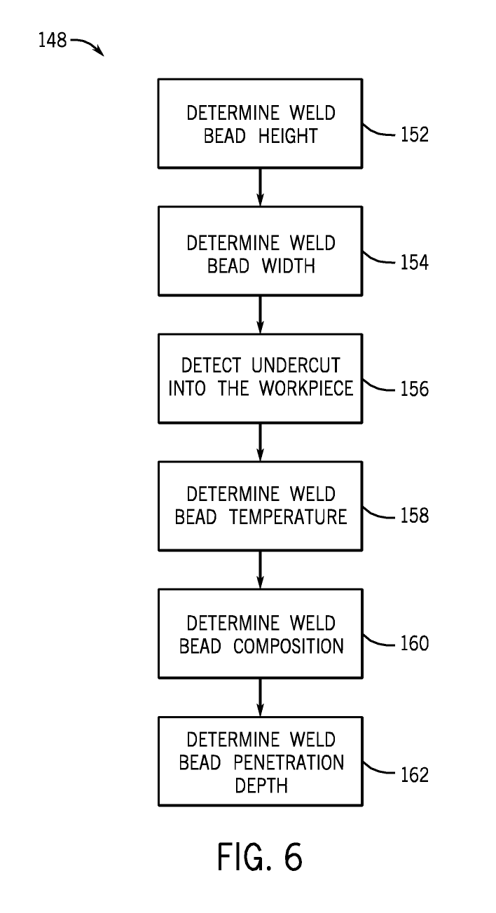

FIG. 6 is a flowchart of a method 148 for detecting welding defects and/or weld bead properties, as represented by block 148 of FIG. 5. As represented by block 152, a weld bead height (h) is determined. As previously discussed, this step may involve performing a differential analysis of images from multiple cameras. Alternatively, the controller 118 may generate a stereoscopic or three-dimensional image from the camera images to determine the geometric properties of the weld bead 106, including bead height (h). Next, the bead width (w) may be determined, as represented by block 154. Similar to the computation of bead height (h), the controller 118 may determine bead width (w) based on the generated stereoscopic or three-dimensional image or a differential analysis of the camera images. Furthermore, as represented by block 156, undercut 136 into the workpiece 102 may be detected. As previously described, undercut 136 is a condition in which workpiece material is worn away during the welding process. Undercut 136 may result in unsatisfactory weld joints because the strength of the surrounding material may be reduced. Based on the location of the undercut 136, the condition may be observed by one camera or multiple cameras. Observation by one camera may enable the controller 118 to detect the condition, while observation by two or more cameras may enable the controller 118 to detect the degree of undercut 136 based on a computation of undercut depth similar to the computation for weld bead height (h).

As represented by block 158, weld bead temperature may be determined. One method to optically determine temperature is to monitor the intensity of various emission frequencies from the hot metal of the weld bead 106. As appreciated, the leading edge of the weld bead 106 may include a molten pool of metal. This liquid metal may represent the highest temperature region of the welding zone 107. Therefore, the weld pool may provide the highest intensity emissions for spectroscopic analysis. As appreciated, temperature may be determined based upon detected spectral emissions. In certain embodiments, the controller 118 may be configured to determine the average temperature of the weld pool and/or the weld bead 106. Alternatively, the controller 118 may compute a three-dimensional temperature distribution of the welding zone 107 based on a spectroscopic analysis of the stereoscopic or three-dimensional image generated in step 146.

As represented by block 160, the weld bead composition may be determined. As previously discussed, this step may involve analyzing the emission spectra to identify individual elements within the welding zone 107. In certain welding operations, the filler material may include relatively small amounts of certain elements not found in the workpiece 102. For example, if the workpiece 102 is composed of aluminum, a substantially aluminum filler may be utilized to strengthen the welding joint. However, the filler material may contain small amounts (e.g., less than 5%, 4%, 3%, 2%, 1%, 0.05%, or 0.01%) of silicon, iron, copper, manganese, magnesium, chromium, zinc, titanium, or beryllium, among other elements. Therefore, the controller 118 may be configured to detect the quantity of these elements to determine the amount of filler present in the weld bead 106. For example, certain aluminum fillers may include approximately 0.1% copper. The quantity of copper present in the filler may be input into the controller 118. The controller 118 may then perform a spectroscopic analysis of images from the welding zone 107 to determine the fraction of copper present in the weld bead 106. Based on a desired quantity of filler material, the controller 118 may determine whether the fraction of copper in the weld bead 106 is consistent with the desired quantity. As appreciated, the controller 118 may be configured to detect the fraction of other elements in the weld bead 106 for aluminum or other workpiece materials. Furthermore, the controller 118 may be configured to compute a three-dimensional composition distribution of the welding zone 107 based on a spectroscopic analysis of the stereoscopic or three-dimensional image generated in step 146.

Finally, as represented by block 162, weld bead penetration depth P may be determined. As previously discussed, the penetration depth P may be computed based on a differential image analysis or a stereoscopic or three-dimensional image generated from cameras 138 and 140 positioned on the reverse side of the workpiece 102 from the welder 104. Ensuring proper penetration depth P may provide enhanced strength of the welded connection.

FIG. 7 is a flowchart of a method 150 for adjusting a parameter affecting weld bead deposition, as represented by block 150 of FIG. 5. First, as represented by block 164, output power of the welder 104 may be adjusted. Output power may be proportional to the heat applied to the welding zone 107. For example, with regard to arc welders, output power may affect the temperature of the arc used to fuse components of the workpiece 102. Similarly, welding laser output power may be adjusted to vary beam intensity. For example, as previously discussed, laser output power may be modified by varying the frequency and/or pulse width of a pulsed welding laser. Excessive welder output power may result in undercut 136. Specifically, the excess power may cause additional melting of the workpiece material, thereby establishing voids adjacent to the weld bead 106. Decreasing output power may substantially reduce or eliminate the undercut 136 condition. Therefore, controller 118 may be configured to reduce welder power if undercut 136 is detected. Similarly, if the controller 118 determines that the temperature of the weld pool or weld bead 106 is outside of a desired range, the controller 118 may adjust output power to compensate.

As represented by block 166, speed of the welder 104 with respect to the workpiece 102 may be adjusted. Specifically, the weld bead height (h), the bead width (w) and the penetration depth P may be inversely proportional to welder speed. For example, as welder speed increases the weld bead height (h), the weld bead width (w) and/or the penetration depth P may decrease. Therefore, the controller 118 may be configured to adjust the rate of movement of the positioning mechanisms 114 and/or 116 to establish a welder speed that provides a bead height (h), bead width (w) and/or penetration depth P within a desired range.

Finally, as represented by block 168, feed rate of filler material into the welding zone 107 may be adjusted. For example, if controller 118 determines that the bead height (h) is less than an established range, the controller 118 may increase the feed rate of filler material into the welding zone 107. Conversely, if the controller 118 determines that the bead width (w) is greater than an established range, the controller 118 may decrease the feed rate of filler material into the welding zone 107. In other words, both the bead height (h) and bead width (w) may be proportional to the feed rate of material. Therefore, the controller 118 may adjust the feed rate to compensate for these detected conditions. Similarly, feed rate of filler material may affect penetration depth P. For example, insufficient feed rate may result in incomplete joint penetration. Therefore, controller 118 may be configured to increase feed rate if the penetration depth P is less than a desired amount. In addition, as previously discussed, the controller 118 may be configured to monitor the quantity of filler material in the weld bead 106 based on a spectroscopic analysis of the weld bead composition. In certain embodiments, a desired quantity of filler material may be input into the controller 118. The controller 118 may then adjust the filler feed rate to provide the desired quantity of filler material into the weld bead 106. By adjusting welder power output, welder speed and/or filler feed rate based on stereoscopic visualization of the welding zone 107, the controller 118 may provide enhanced weld bead formation, thereby increasing joint strength and substantially reducing or eliminating finishing operations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a welder configured to deposit a weld bead on a workpiece;
a plurality of cameras directed toward the weld bead and configured to generate a respective plurality of images; and
a controller configured to generate a stereoscopic image of the weld bead from the plurality of images and to adjust a parameter of weld bead deposition based on the stereoscopic image.

2. The system of claim 1, comprising a light source directed toward the weld bead.

3. The system of claim 1, wherein the welder comprises a welding laser.

4. The system of claim 3, comprising an objective lens configured to focus laser radiation from the welding laser and light from a light source onto the weld bead.

5. The system of claim 1, wherein the welder comprises an electron beam welder, a friction stir welder, an ultrasonic welder, an arc welder, a gas welder, a laser-hybrid welder, an atomic hydrogen welder, a metal inert gas welder, a tungsten inert gas welder, a plasma welder, or a combination thereof.

6. The system of claim 1, wherein the controller is configured to compute a height of the weld bead, a width of the weld bead, or a combination thereof based on the stereoscopic image.

7. The system of claim 1, wherein the controller is configured to detect undercut into the workpiece based on the stereoscopic image.

8. The system of claim 1, wherein the parameter of weld bead deposition comprises an output power of the welder.

9. The system of claim 1, wherein the parameter of weld bead deposition comprises a feed rate of filler material into the weld bead.

10. The system of claim 1, wherein the parameter of weld bead deposition comprises a speed of the welder relative to the workpiece.

11. A system comprising:
a welding controller configured to receive images from a plurality of observation points directed toward a deposition zone, and to control a parameter affecting deposition based on a differential analysis of the images.

12. The system of claim 11, wherein the plurality of observation points comprises a plurality of fiber optic cables optically coupled to at least one camera.

13. The system of claim 11, wherein the welding controller is configured to determine a temperature, a material composition, or a combination thereof of the deposition zone based on the images.

14. The system of claim 11, wherein the welding controller is configured to detect a structural defect in the deposition zone based on the differential analysis of the images.

15. The system of claim 11, wherein the parameter affecting deposition comprises an output power of a welder, a speed of the welder along the deposition zone, a feed rate of material into the deposition zone, or a combination thereof.

16. A system comprising:
a plurality of cameras directed toward a workpiece and configured to generate a respective plurality of images of a welding zone on the workpiece; and
a controller configured to generate a three-dimensional image of the welding zone based on the plurality of images and to adjust a parameter affecting formation of a weld bead within the welding zone based on the three-dimensional image.

17. The system of claim 16, comprising a first plurality of cameras directed toward a first surface of the workpiece upon which the weld bead is deposited, and a second plurality of cameras directed toward a second surface of the workpiece opposite from the first surface.

18. The system of claim 17, wherein the first plurality of cameras is configured to provide images indicative of a temperature of the weld bead, a height of the weld bead, a width of the weld bead, an undercut into the workpiece, a composition of the weld bead, or a combination thereof.

19. The system of claim 17, wherein the second plurality of cameras is configured to provide images indicative of weld penetration depth into the workpiece.

20. The system of claim 16, comprising a light source configured to project light onto the weld bead.
